(19) United States
(12) Patent Application Publication
(10) Pub. No.: US 2026/0225342 A1
(43) Pub. Date: Aug. 6, 2026

(54) COMPOSITE BOARDS WITH IMPROVED STRENGTH

(71) Applicant: Owens Corning Intellectual Capital, LLC, Toledo, OH (US)

(72) Inventors: Shane Polen, Columbus, OH (US); Ankit Gopal Kadakia, Monmouth Junction, NJ (US)

(21) Appl. No.: 19/529,224

(22) Filed: Feb. 4, 2026

Related U.S. Application Data
(60) Provisional application No. 63/754,182, filed on Feb. 5, 2025.

(51) Int. Cl. B32B 5/02; B32B 5/18; B32B 5/24; B32B 13/14

(52) U.S. Cl. CPC B32B 5/022; B32B 5/18; B32B 5/245; B32B 13/14; B32B 2250/40; B32B 2255/02; B32B 2260/021; B32B 2260/048; B32B 2262/101; B32B 2266/0278; B32B 2307/304; B32B 2307/54; B32B 2307/718; B32B 2607/00

(57) ABSTRACT

A composite board is disclosed comprising a core and at least one non-woven mat interfaced with the core, the non-woven mat comprising a plurality of glass fibers having a Young's modulus of greater than or equal to 85 GPa bound together by a binder. The composite board has an improvement in fastener pull-through strength, measured in accordance with ASTM D1761 of greater than or equal to 15%, as compared to an otherwise identical composite board including a non-woven mat comprising a plurality of glass fibers having a Young's modulus of less than 85 GPa.

### CROSS-REFERENCE TO RELATED APPLICATIONS

This application claims priority to and all benefit of U.S. Provisional Patent Application No. 63/754,182, filed on Feb. 5, 2025, the entire disclosure of which is fully incorporated herein by reference.

### FIELD

The general inventive concepts relate to composite boards, and also to non-woven mats for use in composite boards formed from high modulus fiberglass.

### BACKGROUND

Composite boards, such as gypsum, polymer foam, insulation, etc., are generally used in building construction applications, such as roofing systems (insulation, coverboards, decking, and the like), sheathing, and wall boards for use in the partitions or walls of rooms, hallways, ceilings, and the like. Such composite boards may include facing or back mats, such as fiberglass or other woven or non-woven mats, on one or both faces to enhance the performance properties of the board, such as board strength, rigidity, weather durability, and moisture or mold resistance. Such woven or non-woven mats may be manufactured in-line with the wall board or independently thereof.

In such applications, the composite boards are typically attached to a substrate (e.g., framing member, roof deck, etc.) using screws, nails, or other fasteners. One limitation of such a construction is potential for the fastener to pull out of the board, essentially “pulling through” the material due to insufficient holding power. Accordingly, methods for improving fastener pull-through strength are desirable to improve the durability and overall functionality of composite boards.

### SUMMARY

Various exemplary aspects of the present inventive concepts are directed to a composite board comprising a core and at least one non-woven mat interfaced with the core. The non-woven mat comprises a plurality of high modulus glass fibers having a Young's modulus of greater than or equal to 85 GPa bound together by a binder. The composite board has an improvement in fastener pull-through strength, measured in accordance with ASTM D1761 of greater than or equal to 15%, or greater than or equal to 20%, as compared to an otherwise identical composite board including a non-woven mat comprising a plurality of glass fibers having a Young's modulus of less than 85 GPa. Preferably, the composite board has a fastener pull-through strength of at least 175 lbf.

The high modulus glass fibers are formed from a glass composition comprising:
SiO₂ in an amount from 55.0 to 60.4% by weight;
Al₂O₃ in an amount from 19.0 to 25.0% by weight;
CaO in an amount from 7 to 12.0% by weight;
MgO in an amount from 8.0 to 15.0% by weight; and
less than 2% by weight of R₂O, wherein R₂O comprises the sum of Na₂O, K₂O, and Li₂O.

In some aspects, the non-woven mat has a coating on at least one surface. The coating may be applied at an add-on weight of from about 200 gsm to about 400 gsm.

In other aspects, the non-woven mat is impregnated with an impregnation composition. The impregnation composition may be applied in such an amount as to provide an impregnated non-woven mat with a basis weight of from about 150 gsm to about 450 gsm. The coating or impregnation composition comprises an aqueous emulsion or solution of (co) polymers comprising at least one of the following monomers: styrene; (meth)acrylic acid or ester; butyl acrylate; ethyl acrylate; methyl methacrylate, ethylhexyl acrylate; vinyl acetate; vinyl versatate; styrene-butadiene; vinyl alcohol; urea; melamine; phenol; formaldehyde; starch-based monomers; and mixtures thereof.

The core of the composite board may comprise a polymer foam, gypsum, mineral wool, and the like.

Further aspects of the general inventive concepts are directed to the use of a non-woven mat in a composite board, the non-woven mat comprising a plurality of high modulus glass fibers having a Young's modulus of greater than or equal to 85 GPa bound together by a binder. The composite board has an improvement in fastener pull-through strength measured in accordance with ASTM D1761 of greater than or equal to 15% as compared to an otherwise identical composite board including a non-woven mat comprising a plurality of glass fibers having a Young's modulus of less than 85 GPa.

### BRIEF DESCRIPTION OF THE FIGURES

The subject matter of the present disclosure is particularly pointed out and distinctly claimed in the concluding portion of the specification. A more complete understanding of the disclosure, however, may best be obtained by referring to the detailed description and claims when considered in connection with the figures, wherein like numerals denote like elements.

FIG. 1 graphically illustrates the machine direction tensile strength of comparative and inventive coated non-woven facers, tested in accordance with TAPPI-1009.

FIG. 2 graphically illustrates the cross-direction tensile strength of comparative and inventive coated non-woven facers, tested in accordance with TAPPI-1009.

FIG. 3 graphically illustrates the total tensile strength of comparative and inventive coated non-woven facers, tested in accordance with TAPPI-1009.

FIG. 4 graphically illustrates the fastener pull-through strengths according to ASTM D1761 of conventional composite boards comprising coated and impregnated non-woven mats compared to inventive composite boards comprising coated and impregnated non-woven mats comprising high modulus fiberglass.

### DETAILED DESCRIPTION

Unless otherwise defined, all technical and scientific terms used herein have the same meaning as commonly understood by one of ordinary skill in the art to which this application pertains. Although other methods and materials similar or equivalent to those described herein may be used in the practice or testing of the exemplary embodiments, exemplary suitable methods and materials are described below. In case of conflict, the present specification including definitions will control. In addition, the materials, methods, and examples are illustrative only and not intended to be limiting of the general inventive concepts.

The terminology as set forth herein is for description of the exemplary embodiments only and should not be construed as limiting the application as a whole. Unless otherwise specified, “a,” “an,” “the,” and “at least one” are used interchangeably. Furthermore, as used in the description of the application and the appended claims, the singular forms “a,” “an,” and “the” are inclusive of their plural forms, unless contradicted by the context surrounding such.

Unless otherwise indicated, all numbers expressing quantities used in the specification and claims are to be understood as being modified in all instances by the term “about.” The term “about” means within +/−10% of a value, or in some instances, within +/−5% of a value, and in some instances within +/−1% of a value.

Notwithstanding that the numerical ranges and parameters setting forth the broad scope of the exemplary embodiments are approximations, the numerical values set forth in the specific examples are reported as precisely as possible. Any numerical value, however, inherently contains certain errors necessarily resulting from the standard deviation found in their respective testing measurements. Every numerical range given throughout this specification and claims will include every narrower numerical range that falls within such broader numerical range, as if such narrower numerical ranges were all expressly written herein.

All combinations of method or process steps as used herein can be performed in any order, unless otherwise specified or clearly implied to the contrary by the context in which the referenced combination is made. Additionally, all combinations of compositions and compositional ranges may be used in any combination of compositions listed herein.

To the extent that the term “includes” or “including” is used in the description or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” Thus, use of the term “or” herein is the inclusive, and not the exclusive use.

The terms “non-woven,” “mat,” “veil,” and “facer” are used interchangeably herein and refer to a bound web of fibers.

The terms “binder,” “binder composition,” and “curable composition,” as used herein, are used interchangeably and refer to a material that holds one or more components of a non-woven article together. Those of ordinary skill in the art will understand that a binder composition is often an aqueous mixture or solution of dissolved ingredients that cures to interconnect fibers together.

The terms “binder solids” or “binder components,” as used herein, are used interchangeably and refer to the functional ingredients of the binder composition prior to addition or mixing with water to form the ultimate binder for application to the inorganic fibers.

Ranges as used herein are intended to include every number and subset of numbers within that range, whether specifically disclosed or not. Further, these numerical ranges should be construed as providing support for a claim directed to any number or subset of numbers in that range. For example, a disclosure of from 1 to 10 should be construed as supporting a range of from 2 to 8, from 3 to 7, from 5 to 6, from 1 to 9, from 3.6 to 4.6, from 3.5 to 9.9, and so forth.

While the general inventive concepts are susceptible of embodiment in many different forms, there are shown in the drawings, and will be described herein in detail, specific embodiments thereof with the understanding that the present disclosure is to be considered as an exemplification of the principles of the general inventive concepts. Accordingly, the general inventive concepts are not intended to be limited to the specific embodiments illustrated herein.

The general inventive concepts relate to composite boards with improved properties, such as higher fastener pull-through strength, reduced weight, etc. Particularly, it has been surprisingly discovered that composite boards formed with non-woven mats (referred to herein as a facer or, alternatively, a back mat) comprising reinforcement fibers having a Young's modulus of at least 85 GPa demonstrate increased fastener pull-through strength, compared to otherwise identical composite boards formed with conventional glass fibers. Furthermore, it is also possible to reduce the overall weight of the boards, while maintaining mechanical properties consistent with conventional (but heavier) composite boards.

Composite board facing materials generally include non-woven fiber (e.g., fiberglass) mats. Non-woven fiber mats comprise randomly matted fibers bonded together by a cured thermoset or dried thermoplastic polymeric binder. The processes for forming such mats are generally well known, including for example, the well-known wet-laid processing and dry-laid processing methods. In an exemplary process for forming non-woven glass fiber mats, chopped glass fibers may be provided to a conveying apparatus such as a conveyor by a storage container for conveyance to a mixing tank that may contain the white water (e.g., various surfactants, viscosity modifiers, defoaming agents, and/or other chemical agents) with agitation to disperse the fibers and form a chopped glass fiber slurry. The glass fiber slurry may be transferred to a head box where the slurry is deposited onto a conveying apparatus such as a moving screen or foraminous conveyor, and a substantial portion of the water from the slurry is removed to form a web (mat) of enmeshed fibers. The water may be removed from the web by a conventional vacuum or air suction system.

A binder is then applied to the web by a suitable binder applicator, such as by curtain coating, spraying, twin wire dip bath, two roll padder, and the like. Once the binder has been applied to the mat, the binder coated mat is passed through at least one drying oven to remove any remaining water and cure the binder composition. The formed non-woven fiber mat that emerges from the oven is an assembly of randomly oriented, dispersed, individual glass fibers. The fiber mat may be rolled onto a take-up roll for storage or later use.

Alternatively, in a dry-laid process, fibers are chopped and air blown onto a conveyor, after which a binder is then applied and cured to form the mat.

Conventional non-woven fiber mats for use as facing materials on composite boards are formed with glass fibers, such as, for example, A-type glass fibers, C-type glass fibers, E-type glass fibers, S-type glass fibers, ECR-type glass fibers (e.g., Advantex® glass fibers commercially available from Owens Corning of Toledo, Ohio), Hiper-tex® glass fibers, wool glass fibers, H-glass fibers, and combinations thereof.

In particular, conventional facing materials comprise glass fibers having Young's modulus values below 85 GPa. For instance, the Young's modulus of Advantex® glass is about 81 GPa.

It has surprisingly been discovered that the use of non-woven fiber mats formed with fiberglass having a Young's (or elastic) modulus of at least 85 GPa as facing materials in the production of composite boards, increases the fastener pull-through strength of the board, compared to an otherwise identical board formed with a non-woven mat formed with a lower elastic modulus fiber. Such an improvement is particularly surprising since it is generally known and accepted in the art that it is the facer's tensile strength that impacts fastener pull-through strength. One accepted theoretical equation for fastener pull-through strength of sandwich panels is shown below, where: c, α, β, γ=constants, with c=1.92, α=0.015, β=0.055, and γ=0.059; d_{w} (mm) washer diameter; t_{w}=thickness of washer (mm); E_{c}=Young's modulus of the foam core material (MPa); G_{c}=shear strength of the foam core material (MPa); fᵤ=facer tensile strength, t_{f}=facer thickness, and E_{f}=Young's modulus of the facer material; tₚ=foam core thickness (mm).

$${F}_{p} = c [ {t}_{f} {d}_{w} {{f}_{u} ( \frac{{d}_{w}}{{t}_{w}} )}^{α} {( \frac{\sqrt{{E}_{c} {G}_{c}}}{{E}_{f}} )}^{β} {( \frac{{t}_{p}}{{t}_{f}} )}^{γ} ]$$

See Smith, Andrew; Kershaw, Bret; Mahendran, Mahen; and Wanniarachchci, Somadasa, “Local Connection Failures in Composite Sandwich Panel Systems” (2006). International Specialty Conference on Cold-Formed Steel Structures. 3.

As supported by the equation, it may be generally seen that increasing the facer tensile strength likewise increases the fastener pull-through of the composite board. It may be further seen that the fastener pull-through strength of the composite board is inversely affected by the facer's Young's modulus. Namely, reducing the facer's Young's modulus generally increases the fastener pull-though strength of the composite board. However, it has been surprisingly found that the subject fiberglass facers, with Young's modulus of at least 85 GPa, actually result in an increased fastener pull-through strength compared to otherwise identical composite boards formed with conventional glass fibers.

The elastic modulus of a glass fiber may be determined by taking the average measurements on five single glass fibers measured in accordance with the sonic measurement procedure outlined in the report “Glass Fiber and Measuring Facilities at the U.S. Naval Ordnance Laboratory”, Report Number NOLTR 65-87, Jun. 23, 1965.

The glass fibers of the subject invention (referred to herein as “high modulus glass fibers”) have a Young's modulus of at least about 85 GPa, including at least about 88 GPa, at least about 88.5 GPa, at least about 89 GPa, and at least about 89.5 GPa. In some exemplary embodiments, the glass fibers have a Young's modulus of between about 85 GPa and about 95 GPa, including between about 87 GPa and about 92 GPa, and between about 88 GPa and about 91 GPa.

The high modulus glass fibers may be formed from a glass composition including about 55.0 to about 65.0% by weight SiO₂, about 17.0 to about 27.0% by weight Al₂O₃, about 8.0 to about 15.0% by weight MgO, about 7.0 to about 12.0% by weight CaO, about 0.0 to about 1.0% by weight Na₂O, 0 to about 2.0% by weight TiO₂, 0 to about 2.0% by weight Fe₂O₃, and no more than 0.5% by weight Li₂O. The ratio of the weight percent of alumina oxide and magnesium oxide (Al₂O₃/MgO) is no greater than 2.0, such as no greater than 1.9, and no greater than 1.8. Additionally, the ratio of the weight percent of magnesium oxide to calcium oxide (MgO/CaO) is advantageously at least 1.2.

In some aspects, the glass composition may comprise about 57.0 to about 62.0% by weight SiO₂, about 19.0 to about 25.0% by weight Al₂O₃, about 10.5 to about 14.0% by weight MgO, about 7.5 to about 10.0% by weight CaO, about 0.0 to about 0.5% by weight Na₂O, 0.2 to about 1.5% by weight TiO₂, 0 to about 1.0% by weight Fe₂O₃, and no more than 0.1% by weight Li₂O. Preferably, the glass composition includes an Al₂O₃/MgO ratio less than 2 and an MgO/CaO ratio of at least 1.25.

In further aspects, the glass composition may comprise about 57.5 to about 60.0% by weight SiO₂, about 19.5 to about 21.0% by weight Al₂O₃, about 11.0 to about 13.0% by weight MgO, about 8.0 to about 9.5% by weight CaO, about 0.02 to about 0.25% by weight Na₂O, 0.5 to about 1.2% by weight TiO₂, 0 to about 0.5% by weight Fe₂O₃, and no more than 0.05% by weight Li₂O. Preferably, the glass composition includes an Al₂O₃/MgO no greater than 1.8 and an MgO/CaO ratio of at least 1.25.

The glass composition includes at least 55% by weight, but no greater than 65% by weight SiO₂. Including greater than 65% by weight SiO₂ causes the viscosity of the glass composition to increase to an unfavorable level. Moreover, including less than 55% by weight SiO₂ increases the liquidus temperature and the crystallization tendency. Accordingly, the glass composition may include at least 57% by weight SiO₂, including at least 57.5% by weight, at least 58% by weight, at least 58.5% by weight, and at least 59% by weight. In some aspects, the glass composition includes no greater than 60.5% by weight SiO₂, including no greater than 60.3% by weight, no greater than 60.2% by weight, no greater than 60% by weight, no greater than 59.8% by weight, and no greater than 59.5% by weight.

To achieve both the desired mechanical and fiberizing properties, one important aspect of the glass composition is having a Al₂O₃ concentration of at least 19.0% by weight and no greater than 27% by weight. In some aspects, the glass composition includes at least 19.5% by weight Al₂O₃, including at least 19.7% by weight, at least 20% by weight, at least 20.25% by weight, and at least 20.5% by weight.

The glass composition advantageously includes at least 8.0% by weight and no greater than 15% by weight MgO. In some aspects, the glass composition includes at least 9.5% by weight MgO, including at least 10% by weight, at least 10.5% by weight, at least 11% by weight, at least 11.10% by weight, at least 11.25% by weight, at least 12.5% by weight, and at least 13% by weight MgO.

The glass composition may include an Al₂O₃/MgO ratio of no greater than 2.0, such as no greater than 1.9, and no greater than 1.85.

The glass composition advantageously includes at least 7.0% by weight and no greater than 12% by weight CaO. In some aspects, the glass composition includes at least 8.0% by weight CaO, including at least 8.3% by weight, at least 8.5% by weight, at least 8.7% by weight, and at least 9.0% by weight.

In some aspects, the combined amounts of SiO₂, Al₂O₃, MgO, and CaO is at least 98% by weight, or at least 99% by weight, and no greater than 99.5% by weight. For example, the combined amounts of SiO₂, Al₂O₃, MgO, and CaO may be between 98.3% by weight and 99.5% by weight, including between 98.5% by weight and 99.4% by weight and 98.7% by weight and 99.3% by weight.

The glass composition may include up to about 2.0% by weight TiO₂. In some exemplary embodiments, the glass composition includes about 0.01% by weight to about 1.0% by weight TiO₂, including about 0.1% by weight to about 0.8% by weight and about 0.2 to about 0.7% by weight.

The glass composition may include up to about 2.0% by weight Fe₂O₃. In some aspects, the glass composition includes about 0.01% by weight to about 1.0% by weight Fe₂O₃, including about 0.05% by weight to about 0.6% by weight and about 0.1 to about 0.5% by weight.

The glass composition further includes less than 2.0% by weight of the alkali metal oxides Na₂O and K₂O, including between 0 and 1.5% by weight. The glass composition may advantageously include both Na₂O and K₂O in an amount greater than 0.01% by weight of each oxide. In some aspects, the glass composition includes about 0 to about 1% by weight Na₂O, including about 0.01 to about 0.5% by weight, about 0.03 to about 0.3% by weight, and 0.04 to about 0.1% by weight. In some aspects, the glass composition includes about 0 to about 1% by weight K₂O, including about 0.01 to about 0.5% by weight, about 0.03 to about 0.3% by weight, and 0.04 to about 0.1% by weight.

The glass composition may be free or substantially free of B₂O₃, Li₂O, and fluorine, although either, or any, may be added in small amounts to adjust the fiberizing and finished glass properties and will not adversely impact the properties if maintained below several percent. As used herein, substantially free of B₂O₃, Li₂O, and fluorine means that the sum of the amounts of B₂O₃, Li₂O, and fluorine present is less than 1.0% by weight of the composition. The sum of the amounts of B₂O₃, Li₂O, and fluorine present may be less than about 0.5% by weight of the composition, including less than about 0.2% by weight, less than about 0.1% by weight, and less than about 0.05% by weight.

Preferably, the high modulus glass fibers are as described in U.S. Pat. No. 11,214,512, the disclosure of which is fully incorporated herein by reference.

The glass fibers used to form the non-woven fiber mats may have a variety of fiber diameters. The glass fibers used to form the non-woven facers have an average fiber diameter of 5.5 microns to 25 microns. In certain aspects, the glass fibers used to form the non-woven fiber mats have an average fiber diameter of 3 microns to 23 microns, including average fiber diameters of 6 microns to 16 microns, or 11 microns to 13 microns. It is also contemplated that a blend of glass fibers having different fiber diameters, such as a blend of smaller diameter glass fibers (e.g., average fiber diameter of 5.5 microns to 10 microns) and larger diameter glass fibers (e.g., average fiber diameter of 13 microns to 16 microns), may be used to form the non-woven fiber mats.

The glass fibers used to form the non-woven fiber mats may also have a variety of fiber lengths. In certain embodiments, the glass fibers used to form the non-woven fiber mats have an average fiber length of 6.35 mm to 50.8 mm. In certain embodiments, the glass fibers have an average fiber length of 12.7 mm to 38.1 mm. In certain other embodiments, the glass fibers have an average fiber length of 19.05 mm to 25.4 mm. In various exemplary embodiments, the glass fibers have an average length of 25.4 mm to 35 mm. It is also contemplated that a blend of glass fibers having different fiber lengths, such as a blend of shorter glass fibers (e.g., average fiber length of 6.35 mm to 12.7 mm) and longer glass fibers (e.g., average fiber length of 19.05 mm to 31.75 mm), may be used.

As mentioned above, the non-woven fiber mats also include a binder composition to bind the fibers together (may also be referred to as a “precursor” binder). Any conventional binder composition used to form non-woven fiber mats may be used to form the non-woven facers of the present disclosure. In certain embodiments, the binder composition comprises a binder resin material, a coupling agent, and one or more optional additives. The binder resin may be a thermoset material, a thermoplastic material, or a mixture of a thermoset material and a thermoplastic material. In some aspects, the binder resin material comprises any of a latex material, an elastomeric material, acrylic material, styrene-acrylic material, styrene butadiene, a urea formaldehyde material, a melamine formaldehyde material, epoxy, polyurethane, or a combination of the two materials. The acrylic material may comprise polyacrylic acid, such as low molecular weight polyacrylic acid with a weight average molecular weight at or below 10,000 Daltons.

In some aspects, the binder resin material may comprise a blend of urea formaldehyde and a thermoset or thermoplastic acrylic. The thermoset acrylic may comprise an acrylic homopolymer or copolymer. The urea formaldehyde may be present in the binder resin material in an amount from about 70 wt. % to about 95 wt. %, based on the total weight of the binder resin material, including between about 78 wt. % and 92 wt. %, and between about 80 wt. % and about 90 wt. %. The thermoset acrylic may be present in the binder composition in an amount from about 5 wt. % to about 30 wt. %, based on the total weight of the binder resin material, including between about 7 wt. % and 25 wt. %, and about 10 to about 20 wt. %.

The non-woven fiber mats of the present disclosure may have a wide range of basis weights (uncoated). For instance, the non-woven fiber mats may have an uncoated basis weight of 25 g/m² to 300 g/m², such as, for example, non-woven fiber mats have an uncoated basis weight of 30 g/m² to 200 g/m², 40 g/m² to 150 g/m², 50 g/m² to 125 g/m², 55 g/m² to 115 g/m², and 65 g/m² to 100 g/m². In still other embodiments, the non-woven fiber mats have an uncoated basis weight of at least 80 g/m².

The non-woven facer may have a loss on ignition (LOI) in the range of 5 to 45%, which may vary based on the particular binder to glass ratio. In some aspects, the LOI of the non-woven may be between 12 and 40%, including between 15 and 30%, and 17 and 28%.

The non-woven fiber mats (also referred to as “precursor” mats) are coated or impregnated with a coating composition, forming a non-woven facer. As used herein, the term “coating” indicates that the composition is applied to a single surface of the non-woven fiber mat and penetrates through a portion of the thickness of the mat. In contrast, the term “impregnation” indicates that the composition fully penetrates or at least substantially fully penetrates the thickness of the mat. By “substantially fully penetrates” it is meant that the coating composition penetrates at least 75% of the thickness of the non-woven mat.

In some aspects, the non-woven fiber mat is coated, such that the coating composition is applied to a first surface of the non-woven fiber mat and extends partially into the thickness of the mat (i.e., partially through a thickness of the mat measured from a first surface to an opposing second surface), forming a coating layer. The coating layer may extend into the non-woven mat in an amount of up to 75% of the thickness of mat, such as, for example, in an amount of up to 50% of the thickness of the mat. In certain aspects, the coating layer may extend into the non-woven fiber mat in an amount of 10% to 50% of the thickness of non-woven fiber mat, and also including from 5% to 25% of the thickness of the non-woven fiber mat. The non-woven mat may be coated in such a way such that the second surface of the non-woven fiber mat is free of a coating composition. It should be appreciated that the thickness to which the coating layer extends into the non-woven fiber mat may vary somewhat along the width and/or length of the non-woven fiber, or it may be uniform.

Alternatively, the non-woven fiber mats may be impregnated with the coating composition, such that the composition fully penetrates the thickness of the mat. The process of impregnating the non-woven fiber mats may occur according to any known application method, including knife coating, curtain coating, spray coating, roll coating, and the like prior to drying and/or curing the mat.

The coating (or impregnation) composition may comprise a polymeric binder component and optionally a filler component, which may also be referred to as a mineral pigment. Suitable polymeric binders may include latex binders. Exemplary polymeric binders include one or more polymers selected from styrene-butadiene-rubber (SBR), styrene-butadiene-styrene (SBS), ethylene-vinyl-chloride (EVCI), poly-vinylidene-chloride (PVdC), modified poly-vinyl-chloride (PVC), poly-vinyl-alcohol (PVOH), ethylene-vinyl-acetate (EVA), vinyl acetate ethylene (VAE), and poly-vinyl-acetate (PVA). In some aspects, the polymeric binder may be a polymer or copolymer of acrylic acid, methacrylic acid, acrylates, methacrylates, acrylonitrile, and combinations thereof. The amount of polymeric binder in the coating composition may be described as a percent weight of coating binder based on the weight of the total solids (the non-water portion of the coating composition) in the coating composition. In one or more embodiments, the coating composition may include about 2% to about 50% polymeric binder, including, for example, about 4% to about 20% polymeric binder, about 6% to about 15% polymeric binder, and in other embodiments about 5% to about 10% polymeric binder based on the weight of the total solids in the coating composition.

In other aspects, the coating composition may comprise greater than 50% polymeric binder, based on the weight of the total solids in the coating composition, including, for example, at least 70%, at least 80%, or at least 90% polymeric binder. In some aspects, the coating composition includes 95%-100% polymeric binder, based on the weight of the total solids in the coating composition. In such aspects, the coating composition may be free or at least substantially free of filler.

If present, suitable fillers include, but are not limited to, ground limestone (calcium carbonate), clay (kaolin), sand, mica, talc, gypsum (calcium sulfate dihydrate), aluminum trihydrate (ATH), vermiculite, antimony oxide, micronized rubber, or a combination of any two or more of these substances. The amount of filler in the coating composition may be described as a percent weight of filler based on the weight of the total solids (the non-water portion of the coating composition) in the coating composition. When present, the coating composition may include about 65% to about 99% filler, in other embodiments, about 75% to about 98% filler, and in other embodiments about 80% to about 97% filler based on the weight of the total solids in the coating composition. As mentioned above, the coating composition may also be free of filler.

The coating composition may be an aqueous coating composition, including about 15% to about 60% water, or about 20% to about 50% water, or about 30% to about 40% water based on the total weight of the coating composition.

The coating composition of the present disclosure may optionally include one or more additives. Such additives may be included in the coating composition in an amount up to about 10.0 wt. %, including between about 0.5 wt. % and 8 wt. %, and about 1.0 wt. % to about 5.0 wt. %, based on the total weight of the coating composition. Exemplary additives include, but are not limited to, fire retardants, dyes, pigments, UV stabilizers, anti-static agents, film forming agents, viscosity or rheology modifiers, hydrophobic agents, and so forth. Exemplary hydrophobic agents may include fluorochemicals, silicones, waxes, hydrocarbons, or combinations thereof.

If applied as a coating, the composition may be applied to the non-woven fiber mat in an amount from 10 g/m² to 500 g/m², including an amount from 20 g/m² to 350 g/m², and from 50 g/m² to 275 g/m². In certain aspects, the coating composition may be applied to the non-woven fiber mat in an amount from 100 g/m² to 300 g/m², including an amount from 150 g/m² to 275 g/m², and from 175 g/m² to 260 g/m².

If applied as an impregnation coating, the composition may be applied to the non-woven fiber mat in an amount from 5 g/m² to 200 g/m², including an amount from 10 g/m² to 150 g/m², and from 20 g/m² to 125 g/m². In certain aspects, the impregnation coating composition may be applied to the non-woven fiber mat in an amount from 50 g/m² to 150 g/m², including an amount from 75 g/m² to 125 g/m², and from 90 g/m² to 115 g/m².

The high modulus fiberglass facers have a tensile strength measured in accordance with TAPPI-1009 (machine direction, cross-direction, and total tensile strength) that is within at least +/−10% of the tensile strength of an otherwise identical composite board including a non-woven mat comprising a plurality of glass fibers having a Young's modulus of less than 85 GPa. In some aspects, the high modulus fiberglass facers have a tensile strength (machine direction, cross-direction, and total tensile strength) that is within at least +/−5%, or at least +/−2.5%, or at least +/−2%, or at least +/−1% of the tensile strength of an otherwise identical composite board including a non-woven mat comprising a plurality of glass fibers having a Young's modulus of less than 85 GPa.

The high modulus fiberglass facers are used in the manufacture of composite boards, for various applications such as insulation boards, coverboards, gypsum boards, and the like, with improved mechanical properties. One such application is as a facer for a wall board. The facer is intended to be bonded to or otherwise interfaced with a core substrate (e.g., gypsum board, polyiso board, mineral wool insulation board) to form the wall board. Once formed, the wall board can then undergo further processes (e.g., installing, painting).

Wall boards, such as gypsum or polymer foam composite board panels, are used in building construction to form the partitions or walls of rooms, hallways, ceilings, and the like. Similar boards are also used in exterior wall or roof construction, such as sheathing or roof deck. Such composite boards may include front facers or back mats, such as fiberglass or other woven or non-woven mats, on one or both faces to enhance the performance properties of the board, such as board strength, rigidity, weather durability, and moisture or mold resistance. Such woven or non-woven mats may be manufactured in-line with the wall board or independently thereof.

In some aspects, the composite board is higher density coverboard or wall board, such boards comprise a foam core having an average density of at least 3.0 lbs./ft³. In these or other embodiments, the foam core has an average density of about 3.0 lbs./ft³ to about 25 lbs./ft³, and in other embodiments about 4.0 lbs./ft³ to about 8 lbs./ft³. In some exemplary embodiments, the coverboard core has a density of about 3.2 lbs./ft³ to 6 lbs./ft³, or from 3.5 lbs./ft³ to less than 6 lbs./ft³.

In some aspects, the composite boards comprise lower density insulation boards including a foam core having an average density of less than 3.0 lbs./ft³. In some exemplary embodiments, the foam core has an average density of about 1 lbs./ft³ to about 2.8 lbs./ft³, and in other embodiments about 1.5 lbs./ft³ to about 2.0 lbs./ft³. In some exemplary embodiments, the lower density insulation board comprises a foam core with a density below 2.0 lbs./ft³.

As mentioned above, conventional non-woven mats are formed from fiberglass that generally have a Young's modulus that is less than 85 GPa, and seeking higher Young's modulus was discouraged, since such is known to negatively impact fastener pull-through strength. These conventional composite boards have an average fastener pull-through strength of about 125-150 lbf. However, composite boards formed with facing materials comprising high modulus glass fibers demonstrated an increase of fastener pull-through strength of at least 10%, including for example, at least 15%, at least 17%, or at least 20%, compared to otherwise identical composite boards formed with facing materials comprising conventional fiberglass.

Particularly, the composite boards formed in accordance with the subject invention demonstrate a fastener pull-through strength of at least 175 lbf, including, for example, pull-through strengths of at least 180 lbf, 185 lbf, 190 lbf, 195 lbf, 200 lbf, 205 lbf, and 210 lbf, as measured in accordance with modified ASTM D1761. In some aspects, the composite board has a fastener pull-through strength between 175 lbf and 225 lbf, or between 185 lbf and 215 lbf, or between 190 lbf and 215 lbf.

In certain aspects, the composite board is faced with a high modulus fiberglass facer impregnated with 50 g/m² to 150 g/m² of a coating composition, and the board has a fastener pull-through strength of at least 190 lbf, or at least 200 lbf, or at least 210 lbf.

If applied as a coating, the composition may be applied to the non-woven fiber mat in an amount from, including an amount from 20 g/m² to 350 g/m², and from 50 g/m² to 275 g/m². In certain aspects, the coating composition may be applied to the non-woven fiber mat in an amount from 100 g/m² to 300 g/m², including an amount from 150 g/m² to 275 g/m², and from 175 g/m² to 260 g/m².

In certain aspects, the composite board is faced with a high modulus fiberglass facer coated with 150 g/m² to 275 g/m² of a coating composition, and the board has a fastener pull-through strength of at least 160 lbf, or at least 170 lbf, or at least 175 lbf.

### EXAMPLES

### Example 1

Trials were conducted to compare the mechanical properties of conventional coated fiberglass facers with that otherwise identical facers formed with high modulus fiberglass. The coated fiberglass facers each comprised a precursor mat formed of 13-micron diameter glass fibers with an average length of 0.75 inches. The precursor mats were bound with a binder composition comprising a blend of 90 wt. % urea formaldehyde and 10 wt. % acrylic. Samples were produced at three different precursor LOIs: 22%, 25%, and 28%. The precursor mats had basis weight of 2.0 lbs./100 ft². The conventional facers were formed with commercial fiberglass having a Young's modulus of about 80 GPa (Comparative Examples 1a (22%), 1b (25%), and 1c (28%)) and the inventive facers were formed with high modulus fiberglass, with an elastic modulus greater than 85 GPa (Examples 1a (22%), 1b (25%), and 1c (28%)).

The precursor mats were coated with a coating composition comprising (based on dry weight % solids) as described in Table 1 below, forming coated fiberglass facers.

TABLE 1

| Composition | Wt. % solids |
|---|---|
| Acrylic latex binder | 7.0 wt. % |
| Calcium carbonate filler | 92.7 wt. % |
| Dispersant | 0.125 wt. % |
| HASE rheology modifier | 0.155 wt. % |
| Add-on Weight | 5.25 lbs./100 ft² |

The facers were then tested for tensile strength (machine direction (MD), cross direction (CD), and total tensile strength), each measured in accordance with TAPPI-1009.

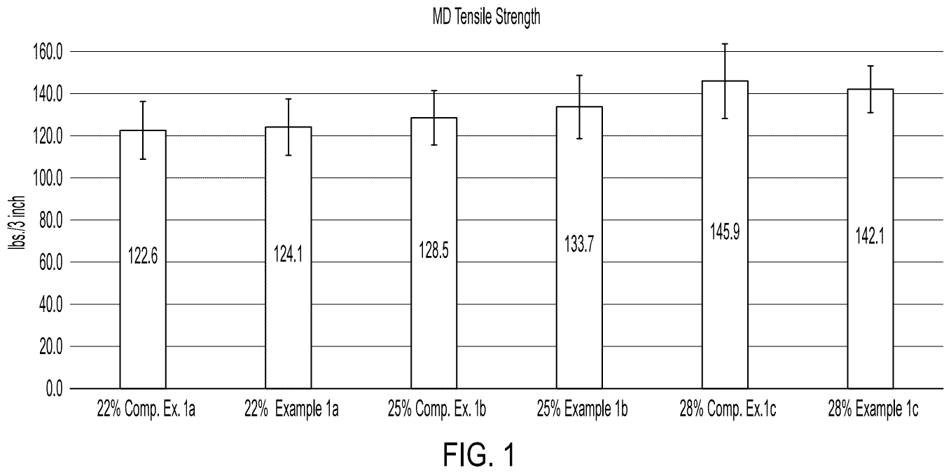

As illustrated in FIG. 1, Examples 1a-1c demonstrated machine direction tensile strengths that were generally consistent with those of the Comparative Examples. Particularly, each of Examples 1a and 1b showed slight improvement over Comparative Examples 1a and 1b, but each Example was at least within +/−5% of the machine direction tensile strength of the Comparative.

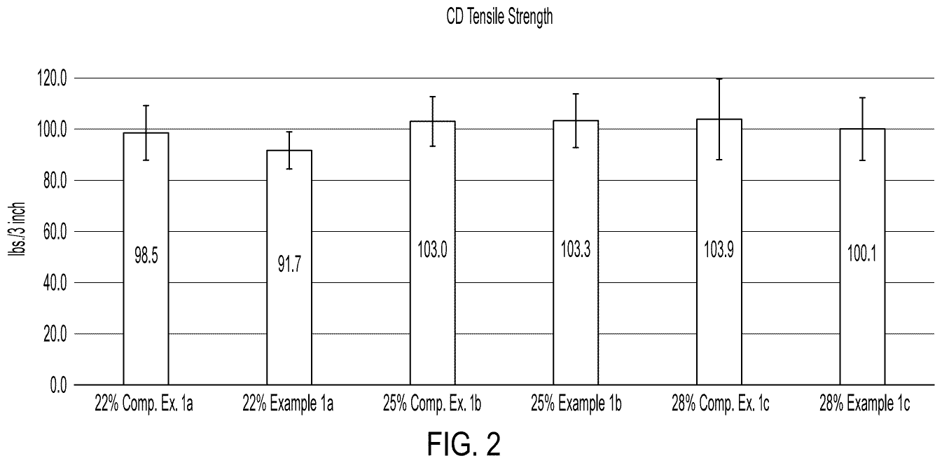

Similar results are seen in FIG. 2, which illustrates the cross-direction tensile strength for each Example and Comparative Example. As shown in FIG. 2, each of Examples 1a, 1b, and 1c were within +/−5% of the cross-direction tensile strength of the Comparative.

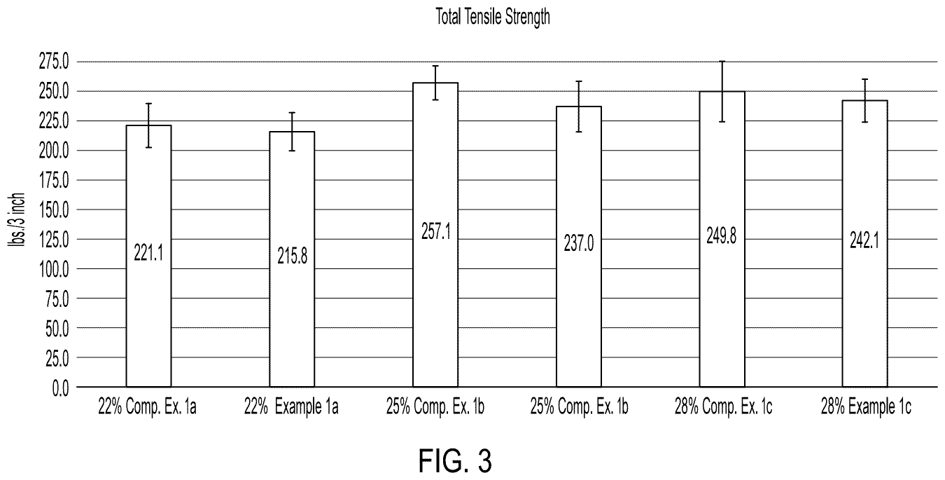

Similar results are seen in FIG. 3, which illustrates the total tensile strength for each Example and Comparative Example.

### Example 2

Comparative Example 1b and Example 1b (each with 25% LOI) from Example 1 were then each applied to one surface of a polyisocyanate foam board (about 4 lbs./ft³ density), forming Comparative Example 2a and Example 2b. Additional facers were prepared comprising a conventional (Comparative Example 3a) and inventive (Example 3b) precursor mat, respectively. Comparative Example 3a and Example 3b were impregnated with an impregnation composition comprising 100 wt. % vinyl acetate ethylene in an add-on amount of 2.0 lbs./100 ft². Comparative Example 3a and Example 3b were then applied to one surface of a polyisocyanate board (about 4 lbs./ft³ density).

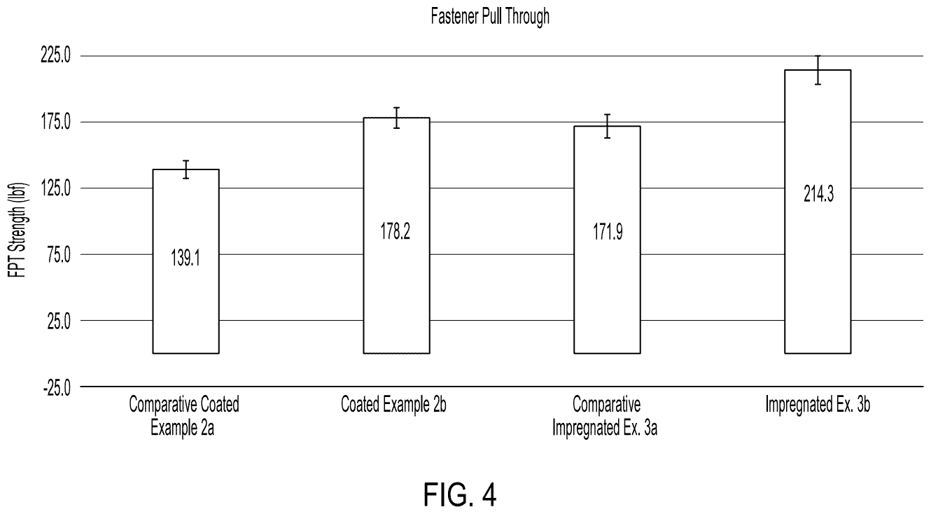

The fastener pull-through strength for each Example was then tested in accordance with modified ASTM D1761, Standard Test Methods for Mechanical Fasteners in Wood. The modification included using a 3″ ribbed galvalume plate and a 4″ fastener. As illustrated in FIG. 4, Comparative Example 2a demonstrated an average fastener pull-through strength of 139.1 lbf, while Example 2b demonstrated a significantly improved fastener pull-through of 178.2 lbf. Similarly for the impregnated samples, Comparative Example 3a demonstrated a fastener pull-through strength of 171.9 lbf, while Example 3b demonstrated another significant improvement at 214.3 lbf. Thus, the gypsum boards faced with the inventive fiberglass facers showed a surprisingly improved fastener pull-through strength, compared to conventional gypsum boards.

All ranges and parameters, including but not limited to percentages, parts, and ratios, disclosed herein are understood to encompass any and all sub-ranges assumed and subsumed therein, and every number between the endpoints. For example, a stated range of “1 to 10” should be considered to include any and all subranges between (and inclusive of) the minimum value of 1 and the maximum value of 10; that is, all subranges beginning with a minimum value of 1 or more (e.g., 1 to 6.1), and ending with a maximum value of 10 or less (e.g., 2.3 to 9.4, 3 to 8, 4 to 7), and finally to each number 1, 2, 3, 4, 5, 6, 7, 8, 9, and 10 contained within the range.

The composite non-woven mats of the present disclosure can comprise, consist of, or consist essentially of the essential elements and limitations of the disclosure as described herein, as well as any additional or optional components or limitations described herein or otherwise useful in non-woven mat applications.

In some embodiments, it may be possible to utilize the various inventive concepts in combination with one another. Additionally, any particular element recited as relating to a particularly disclosed embodiment should be interpreted as available for use with all disclosed embodiments, unless incorporation of the particular element would be contradictory to the express terms of the embodiment. Additional advantages and modifications will be readily apparent to those skilled in the art. Therefore, the disclosure, in its broader aspects, is not limited to the specific details presented therein, the representative apparatus, or the illustrative examples shown and described. Accordingly, departures may be made from such details without departing from the spirit or scope of the general inventive concepts.

The scope of the general inventive concepts presented herein are not intended to be limited to the particular exemplary embodiments shown and described herein. From the disclosure given, those skilled in the art will not only understand the general inventive concepts and their attendant advantages, but will also find apparent various changes and modifications to the devices, systems, and methods disclosed. It is sought, therefore, to cover all such changes and modifications as fall within the spirit and scope of the general inventive concepts, as described and/or claimed herein, and any equivalents thereof.

What is claimed is:

1. A composite board comprising:
a core; and
at least one non-woven mat interfaced with the core, the non-woven mat comprising a plurality of glass fibers having a Young's modulus of greater than or equal to 85 GPa bound together by a binder;
wherein the composite board has an improvement in fastener pull-through strength, measured in accordance with ASTM D1761 of greater than or equal to 15%, as compared to an otherwise identical composite board including a non-woven mat comprising a plurality of glass fibers having a Young's modulus of less than 85 GPa.

2. The composite board of claim 1, wherein the improvement in fastener pull-through strength of the composite board is greater than or equal to 20% as compared to an otherwise identical composite board including a non-woven mat comprising a plurality of glass fibers having a Young's modulus of less than 85 GPa.

3. The composite board of claim 1, wherein the composite board has a fastener pull-through strength of at least 175 lbf.

4. The composite board of claim 1, wherein the non-woven mat has a cross-direction tensile strength that is within ±10% of a cross-directional tensile strength of an otherwise identical non-woven mat comprising a plurality of glass fibers having a Young's modulus of less than 85 GPa.

5. The composite board of claim 1, wherein the non-woven mat has a machine-direction tensile strength that is within ±10% of a machine-direction tensile strength of an otherwise identical non-woven mat comprising a plurality of glass fibers having a Young's modulus of less than 85 GPa.

6. The composite board of claim 1, wherein the non-woven mat has a machine-direction tensile strength that is within ±5% of a machine-direction tensile strength of an otherwise identical non-woven mat including a non-woven mat comprising a plurality of glass fibers having a Young's modulus of less than 85 GPa.

7. The composite board of claim 1, wherein the non-woven mat has a basis weight of from about 50 gsm to about 150 gsm.

8. The composite board of claim 1, wherein the glass fibers are formed from a glass composition comprising:
SiO₂ in an amount from 55.0 to 60.4% by weight;
Al₂O₃ in an amount from 19.0 to 25.0% by weight;
CaO in an amount from 7 to 12.0% by weight;
MgO in an amount from 8.0 to 15.0% by weight; and
less than 2% by weight of R₂O, wherein R₂O comprises the sum of Na₂O, K₂O, and Li₂O.

9. The composite board of claim 1, wherein the at least one non-woven mat has a coating on at least one surface thereof.

10. The composite board of claim 9, wherein the coating is applied at an add on weight of from about 200 gsm to about 400 gsm.

11. The composite board of claim 1, wherein the at least one non-woven mat is impregnated with an impregnation composition.

12. The composite board of claim 11, wherein the impregnated non-woven mat has a basis weight of from about 150 gsm to about 450 gsm.

13. The composite board of claim 11, wherein the impregnation composition comprises a latex emulsion or solution-based binder.

14. The composite board of claim 1, wherein the binder of the non-woven mat comprises an aqueous emulsion or solution of (co) polymers comprising at least one of the following monomers: styrene; (meth)acrylic acid or ester; butyl acrylate; ethyl acrylate; methyl methacrylate, ethylhexyl acrylate; vinyl acetate; vinyl versatate; styrene-butadiene; vinyl alcohol; urea; melamine; phenol; formaldehyde; starch-based monomers; and mixtures thereof.

15. The composite board of claim 1, wherein the non-woven mat has an LOI of from about 20% to about 28%.

16. The composite board of claim 1, wherein the core comprises a polymer foam.

17. The composite board of claim 1, wherein the core comprises a gypsum core.

18. The use of a non-woven mat in a composite board, the non-woven mat comprising a plurality of glass fibers having a Young's modulus of greater than or equal to 85 GPa bound together by a binder, wherein the composite board has an improvement in fastener pull-through strength measured in accordance with ASTM D1761 of greater than or equal to 15% as compared to an otherwise identical composite board including a non-woven mat comprising a plurality of glass fibers having a Young's modulus of less than 85 GPa.
